(19) United States
(12) Patent Application Publication
(10) Pub. No.: US 2014/0025575 A1
(43) Pub. Date: Jan. 23, 2014

(54) TECHNIQUES FOR OUT-OF-BAND TRANSACTION VERIFICATION

(71) Applicant: Jasmeet Chhabra, Hillsboro, OR (US)

(72) Inventor: Jasmeet Chhabra, Hillsboro, OR (US)

(21) Appl. No.: 13/554,240

(22) Filed: Jul. 20, 2012

(51) Int. Cl. G06Q 20/40

(52) U.S. Cl. 705/44

(57) ABSTRACT

Various embodiments are generally directed to cooperation among networked devices to seek out-of-band verification that an online transaction is requested by a person authorized to do so. An apparatus comprises a processor circuit and a storage communicatively coupled to the processor circuit and storing a sequence of instructions operative on the processor circuit to receive a transaction request requesting performance of a transaction via a first communications channel from a transaction device; transmit a verification request to another computing device via a second communications channel; receive a response to the verification request via the second communications channel; and perform the transaction in response to an indication in the response that the transaction has been verified. Other embodiments are described and claimed herein.

### BACKGROUND

Monetary, financial and other transactions of considerable value have started to be routinely conducted online, rather than in person and/or through paperwork conveyed through the mail or by courier. Purchases, bank account transactions, payment of bills, trades in various financial instruments, secured transactions, bonds, commodities transactions, and other transactions are now routinely made by consumers accessing a website hosted on a distant server through a web browser, or by other similar use of computing devices.

Unfortunately, while conducting such transactions between computing devices has reduced costs for businesses and offered greater convenience for consumers, it has also increased opportunities for fraudulent transactions to be carried out. Many computing devices used by consumers to perform such transactions have been found to be infiltrated by malicious software designed to record keystrokes or otherwise obtain passwords, account numbers and/or other information useful to criminals in performing fraudulent transactions to steal funds from consumers and/or in assuming the identities of consumers to perform fraudulent transactions to purchase goods at the expense of consumers. Further, it is not uncommon for consumers to misplace portable devices on which they conduct their transactions or to have those portable devices stolen such that someone else is able to immediately obtain access to information useful in performing such fraudulent transactions.

While consumers have been provided with various measures to at least mitigate the risks of criminals obtaining the information needed to perform fraudulent transactions, such measures often have drawbacks. Passwords are commonly used to control online access to accounts, but it has proven to be commonplace for consumers to create and use passwords that are often “weak” (e.g., easily guessed by others). Anti-virus software for computing devices used by consumers to perform such transactions can be cumbersome and confusing for non-technical users to work with, and can undesirably consume the processing and other resources of those computing devices to a degree that frustrates use of those computing devices by consumers. Facilities built into portable computing devices to secure them against unwanted use by others (e.g., passwords) are often not employed by consumers who prefer to be able to make use of such devices on a spur-of-the-moment basis without having to verify who they are. It is with respect to these and other considerations that the techniques described herein are needed.

### BRIEF DESCRIPTION OF THE DRAWINGS

FIG. 1 illustrates a first embodiment of interaction among computing devices.

FIG. 2 illustrates a portion of the embodiment of FIG. 1.

FIG. 3 illustrates a second embodiment of interaction among computing devices.

FIG. 4 illustrates a third embodiment of interaction among computing devices.

FIG. 5 illustrates an embodiment of a first logic flow.

FIG. 6 illustrates an embodiment of a second logic flow.

FIG. 7 illustrates an embodiment of a third logic flow.

FIG. 8 illustrates an embodiment of a fourth logic flow.

FIG. 9 illustrates an embodiment of a processing architecture.

### DETAILED DESCRIPTION

Various embodiments are generally directed to cooperation among networked devices to seek out-of-band verification that an online transaction is requested by a person authorized to do so. Some embodiments are particularly directed to interaction among at least a transaction server and a verification device to contact an authorized person through a second communications channel to seek verification that a requested online transaction is authorized.

More specifically, in an interaction between a transaction device and a transaction server through a first communications channel in which an online transaction (e.g., an online purchase, transfer of funds, bill payment, trade in financial instruments, secured transaction, commodities transaction, etc.) is requested, the transaction server transmits a verification request to another computing device seeking verification from the person purported to have requested the transaction through a second communications channel as to whether or not that person did indeed request that online transaction. The other computing device may be a verification server with which that person has registered a verification device by which that person may be automatically contacted through the second communications channel to seek the verification. Alternatively, where the transaction server also functions as a verification server such that the verification device is more directly registered with the transaction server, the other computing device may be the verification device, itself. Upon the verification request being answered in the affirmative to the effect that the online transaction was requested by that person, the transaction server performs the transaction (either itself, or in cooperation with one or more other transaction servers).

In one embodiment, for example, an apparatus comprises a processor circuit and a storage communicatively coupled to the processor circuit and storing a sequence of instructions operative on the processor circuit to receive a transaction request requesting performance of a transaction via a first communications channel from a transaction device; transmit a verification request to another computing device via a second communications channel; receive a response to the verification request via the second communications channel; and perform the transaction in response to an indication in the response that the transaction has been verified. Other embodiments are described and claimed herein.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may comprise a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

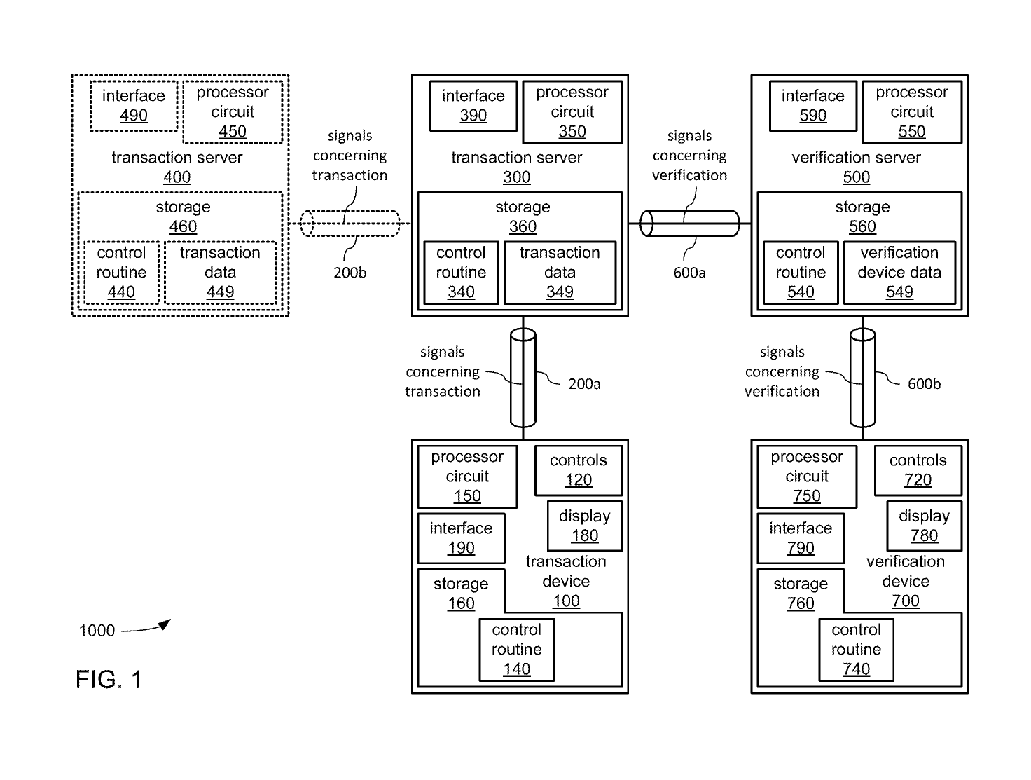

FIG. 1 illustrates a block diagram of a transaction system 1000 comprising one or more of a transaction device 100, a transaction server 300, a verification server 500, a verification device 700, and possibly also another transaction server 400. Each of the computing devices 100, 300, 400, 500 and 700 may be any of a variety of types of computing device, including without limitation, a desktop computer system, a data entry terminal, a laptop computer, a netbook computer, a tablet computer, a handheld personal data assistant, a smartphone, a body-worn computing device incorporated into clothing, a computing device integrated into a vehicle, a server, a cluster of servers, a server farm, etc. In various embodiments, the transaction device 100 and the transaction server 300 exchange signals concerning a transaction via a link 200a, the transaction servers 300 and 400 (if both are present) exchange signals concerning the transaction via a link 200b, the transaction server 300 and the verification server 500 exchange signals concerning verification of who requested the transaction via a link 600a, and the verification server 500 and the verification device 700 exchange signals concerning such verification via a link 600b. Each of the links 200a, 200b, 600a and 600b may be based on any of a variety (or combination) of communications technologies by which signals may be exchanged, including without limitation, wired technologies employing electrically and/or optically conductive cabling, and wireless technologies employing infrared, radio frequency or other forms of wireless transmission. It is envisioned that one or more of the links 200a-b and 600a-b are implemented as channels of communication (e.g., VPN channels or other forms of virtual channels) formed between computing devices through portions of the Internet.

In various embodiments, and as will be explained in greater detail, the transaction device 100 signals the transaction server 300 through the link 200a with a transaction request comprising an indication of the identity of the person purportedly operating the transaction device 100 to request performance of a transaction involving an organization (e.g., a bank, a credit union, a broker, a trading company, an insurer, a law firm, a tax firm, an accountancy firm, or other organization performing, servicing or supporting the performance of transactions) with which the transaction server 300 is associated. In turn, the transaction server 300 signals the verification server 500 through the link 600a with a verification request comprising an indication of the identity indicated in the transaction requested as purportedly being the person who requested the transaction and an indication of one or more aspects of the requested transaction (e.g., an amount, an item to be transferred, an identity of to where or from where an amount or thing of value is to be transferred, etc.). In turn, the verification server 500 signals the verification device 700 through the link 600b with a verification request, the verification device 700 having been earlier registered as a computing device belonging to the person identified in the transaction request as the person purportedly requesting the transaction. In turn, the verification device 700 visually, audibly and/or in some other perceivable way presents a request for verification that the requested transaction has been requested by the person identified in the transaction request. The verification device 700 then signals the verification server 500 through the link 600b with an indication that the requested transaction has been verified as having been requested by the person so identified, with an indication that the requested transaction has been indicated to the verification device 700 as not being requested by the person so identified (thus, not verified), or with an indication that no person has responded to the request for verification presented by the verification device 700 within a defined period of time tracked by the verification device (thus, not verified). The verification server 500 signals the transaction server 300 through the link 600a to relay the indication received from the verification device 700, and in turn, the transaction server 300 acts to either perform the requested transaction or deny it, as appropriate. Where the transaction server 300 acts to perform the requested transaction, and where the requested transaction entails cooperation between at least the transaction server 300 and another transaction server 400 (e.g., where the transaction servers 300 and 400 are associated with different institutions that must cooperate for the transaction to be performed), the transaction server 300 signals the transaction server 400 through the link 200b with information concerning the requested transaction to enable such cooperation between them.

This use of at least the link 600b as a second channel of communication that is separate from the first channel of communication comprising at least the link 200a is a use of an out-of-band communications channel to seek verification that the transaction requested through the link 200a is actually requested by the person that is purported to have requested it. Such use of another channel of communication enhances the security with which transactions are performed, since a criminal would have to be able to both make the transaction request and answer the request for verification to successfully perform a fraudulent transaction.

In various embodiments, the transaction device 100 comprises a storage 160 storing at least a control routine 140, a processor circuit 150, controls 120, a display 180, and an interface 190 coupling the transaction device to the link 200a. In executing a sequence of instructions of at least the control routine 140, the processor circuit 150 is caused to monitor the controls 120 and operate the display 180 to enable a user of the transaction device 100 to operate the controls 120 to signal the processor circuit 150 with an indication that the user wishes to perform a transaction. Upon being so signaled, the processor circuit 150 operates the interface 190 to transmit a transaction request comprising details of this desired transaction to the transaction server 300 through the link 200a.

In various embodiments, the transaction server 300 comprises a storage 360 storing at least a control routine 340 and transaction data 349, a processor circuit 350, and an interface 390 coupling the transaction server 300 to the links 200a-b and 600a. In executing a sequence of instructions of at least the control routine 340, the processor circuit 350 is caused to operate the interface 390 to receive the transaction request from the transaction device 100 through the link 200a. The transaction request comprises an indication of an identity of what is purported to be the person requesting the desired transaction to be performed and some indication of an aspect of the transaction (e.g., an amount, to whom or from whom, etc.), and the processor circuit 350 is caused to store this information within the storage 360 as the transaction data 349. In response to receiving the transaction request, the processor circuit 350 is caused to operate the interface 390 to signal the verification server 500 through the link 600a with a verification request, the verification request conveying the purported identity of the person making the transaction request, along with one or more details of the requested transaction (e.g., the amount, to or from whom, etc.).

In various embodiments, the verification server 500 comprises a storage 560 storing at least a control routine 540 and verification device data 549, a processor circuit 550, and an interface 590 coupling the verification server to the links 600a-b. In executing a sequence of instructions of at least the control routine 540, the processor circuit 550 is caused to operate the interface 590 to receive the verification request from the transaction server 300 through the link 600a. In response to receiving the verification request, the processor circuit 550 is caused to retrieve from the verification device data 549 information identifying the verification device 700 as being associated with the person identified in the verification request received from the transaction server 300 as purportedly being the person requesting the transaction. At an earlier time, the verification server 500 was provided with information identifying the verification device 700 as being associated with that person, and the processor circuit 550 was caused to store that information as part of the verification device data 549. It may be that the organization with which the verification server 500 is associated required some form of proof of the identity of the person and/or of their ownership (or other form of association) with the verification device 700 under circumstances that more readily enabled such proof to be provided under controlled conditions. The processor circuit 550 is then caused to signal the verification device 700 through the link 600b with a verification request, the verification request conveying one or more details of the requested transaction.

In various embodiments, the verification device 700 comprises a storage 760 storing at least a control routine 740, a processor circuit 750, controls 720, a display 780, and an interface 790 coupling the verification device 700 to the link 600b. In executing a sequence of instructions of at least the control routine 740, the processor circuit 750 is caused to operate the interface 790 to receive the verification request from the verification server 500 through the link 600b. In response to receiving this verification request, the processor circuit 750 is caused to visually present a request for verification that the user of the verification device 700 did request the transaction on the display 780 and/or to present this request in some other way selected to be perceivable by a user of the verification device 700 (e.g., audibly via computer-generated speech, mechanical vibration of the verification device 700 to draw the user's attention, etc.). The processor circuit 750 is also caused to monitor the controls 720 for an indication of operation of the controls 720 by a person that is indicative of a response to the presented request for verification. If, within a defined period of time, the processor circuit 750 is signaled by the controls 720 with an indication of a response to the presented request, then the processor circuit 750 is caused to signal the verification server 500 through the link 600b with an indication of that response. However, if the processor circuit 750 is not signaled by the controls 720 with an indication of a response to the presented request within that defined period of time, then the processor circuit 750 is then caused to signal the verification server 500 through the link 600b with an indication that no response to the presented request has been received.

Upon receiving an indication of either a response or lack of response to the presented request from the verification device 700 through the link 600b, the processor 550 of the verification server 500 is caused to respond by operating the interface 590 to convey an indication of the response or lack of response to the transaction server 300. In turn, in response to receiving the indication of the response or lack of response to the presented request from the verification server 500, the processor circuit 350 is caused to act to either perform or deny the requested transaction, as appropriate. Where the transaction server 300 acts to perform the requested transaction, and where the requested transaction entails cooperation between at least the transaction servers 300 and 400, the transaction server 300 signals the transaction server 400 to enable that cooperation.

In various embodiments, the transaction server 400 (if present) comprises a storage 460 storing at least a control routine 440 and transaction data 449, a processor circuit 450, and an interface 490 coupling the transaction server 400 to the link 200b. In executing a sequence of instructions of at least the control routine 440, the processor circuit 450 is caused to operate the interface 490 to receive a signal from the transaction server 300 through the link 200b conveying information enabling the transaction servers 300 and 400 to cooperate to perform the transaction following the transaction server 300 receiving an indication from the verification server 500 that the transaction has been verified as being requested by the person identified in the transaction request received from the transaction device 100. The information received from the transaction server 300 comprises one or more aspects of the transaction (e.g., an amount, to whom or from whom, etc.), and the processor circuit 450 is caused to store this information within the storage 460 as the transaction data 449. In response to receiving this information, the processor circuit 450 is caused to operate the interface 490 as needed to enable the cooperation between the transaction servers 300 and 400.

In various embodiments, each of the processor circuits 150, 350, 450, 550 and 750 may comprise any of a wide variety of commercially available processors, including without limitation, an AMD® Athlon®, Duron® or Opteron® processor; an ARM® application, embedded and secure processors; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may comprise a multi-core processor (whether the multiple cores coexist on the same or separate dies), and/or a multi-processor architecture of some other variety by which multiple physically separate processors are in some way linked.

In various embodiments, each of the storages 160, 360, 460, 560 and 760 may be based on any of a wide variety of information storage technologies, possibly including volatile technologies requiring the uninterrupted provision of electric power, and possibly including technologies entailing the use of machine-readable storage media that may or may not be removable. Thus, each of these storages may comprise any of a wide variety of types of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may comprise multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM).

In various embodiments, each of the interfaces 190, 390, 490, 590 and 790 employ any of a wide variety of signaling technologies enabling each of computing devices 100, 300, 400, 500 and 700 to be coupled through one or more of the links 200a-b and 600a-b as has been described. Each of these interfaces comprises circuitry providing at least some of the requisite functionality to enable access to one or more of these links. However, each of these interfaces may also be at least partially implemented with sequences of instructions executed by corresponding ones of the processor circuits 150, 350, 450, 550 and 750 (e.g., to implement a protocol stack or other features). Where one or more of the links 200a-b and 600a-b employs electrically and/or optically conductive cabling, corresponding ones of the interface 190, 390, 490, 590 and 790 may employ signaling and/or protocols conforming to any of a variety of industry standards, including without limitation, RS-232C, RS-422, USB, Ethernet (IEEE-802.3) or IEEE-1394. Alternatively or additionally, where one or more of the links 200a-b and 600a-b entails the use of wireless signal transmission, corresponding ones of the interfaces 190, 390, 490, 590 and 790 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 190, 390, 490, 590 and 790 are depicted as a single block, one or more of these may comprise multiple interfaces that may be based on differing signaling technologies. This may be the case especially where one or more of these interfaces couples corresponding ones of the computing devices 100, 300, 400, 500 and 700 to more than one of the links 200a-b and 600a-b that employ differing communications technologies.

In various embodiments, each of the controls 120 and 720 may comprise any of a variety of types of manually-operable controls, including without limitation, lever, rocker, pushbutton or other types of switches; rotary, sliding or other types of variable controls; touch sensors, proximity sensors, heat sensors or bioelectric sensors, etc. Each of the controls 120 and 720 may comprise manually-operable controls disposed upon a casing of corresponding ones of the computing devices 100 and 700, and/or may comprise manually-operable controls disposed on a separate casing of a physically separate component of corresponding ones of these computing devices (e.g., a remote control coupled to other components via infrared signaling). Alternatively or additionally, the controls 120 and 720 may comprise any of a variety of non-tactile user input components, including without limitation, a microphone by which sounds may be detected to enable recognition of a verbal command; a camera through which a face or facial expression may be recognized; an accelerometer by which direction, speed, force, acceleration and/or other characteristics of movement may be detected to enable recognition of a gesture; etc.

In various embodiments, each of the displays 180 and 780 may be based on any of a variety of display technologies, including without limitation, a liquid crystal display (LCD), including touch-sensitive, color, and thin-film transistor (TFT) LCD; a plasma display; a light emitting diode (LED) display; an organic light emitting diode (OLED) display; a cathode ray tube (CRT) display, etc. Each of these displays may be disposed on a casing of corresponding ones of the computing devices 100 and 700, or may be disposed on a separate casing of a physically separate component of corresponding ones of these computing devices (e.g., a flat panel monitor coupled to other components via cabling).

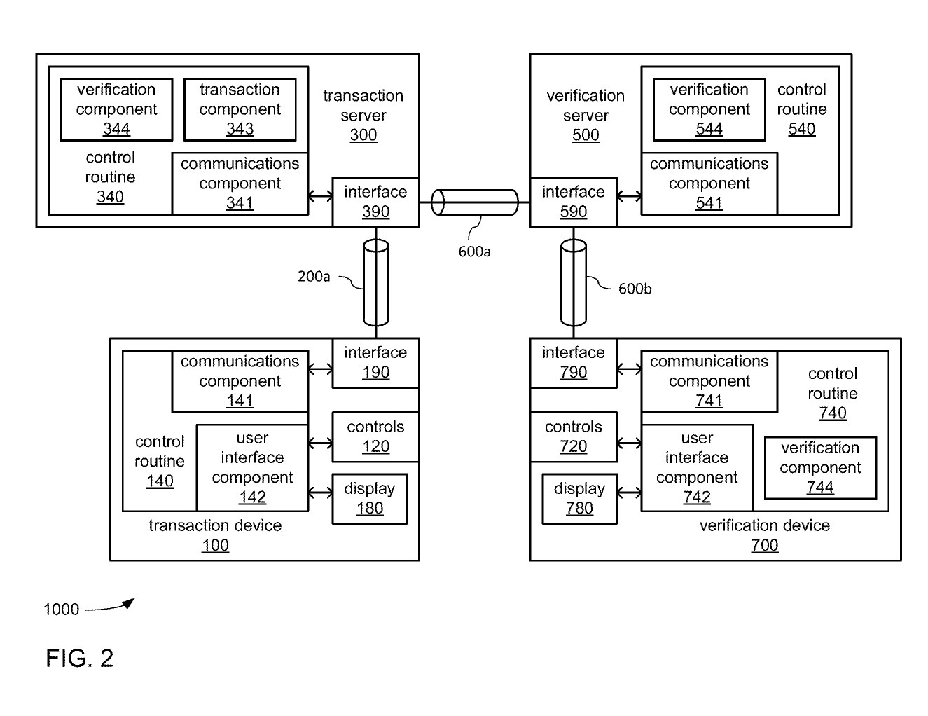

FIG. 2 illustrates a block diagram of a portion of the block diagram of FIG. 1 in greater detail. More specifically, aspects of the operating environments of the transaction device 100, the transaction server 300, the verification server 500 and the verification device 700 in which their respective processor circuits 150, 350, 550 and 750 (shown in FIG. 1) are caused by execution of their respective control routines 140, 340, 540 and 740 to perform the aforedescribed functions are depicted. As will be recognized by those skilled in the art, each of the control routines 140, 340, 540 and 740, including the components of which each is composed, are selected to be operable on whatever type of processor or processors that are selected to implement each of the processor circuits 150, 350, 550 and 750.

In various embodiments, one or more of the control routines 140, 340, 540 and 740 may comprise a combination of an operating system, device drivers and/or application-level routines. Where an operating system is included, the operating system may be any of a variety of available operating systems appropriate for whatever corresponding ones of the processor circuits 150, 350, 550 and 750, including without limitation, Windows™, OS X™, Linux®, or Android OS™. Where one or more device drivers are included, those device drivers may provide support for any of a variety of other components, whether hardware or software components, that comprise one or more of the computing devices 100, 300, 500 and 700.

Each of the control routines 140, 340, 540 and 740 comprise a communications component 141, 341, 541 and 741, respectively, executable by corresponding ones of the processing circuits 150, 350, 550 and 750 to operate corresponding ones of the interfaces 190, 390, 590 and 790 to transmit and receive signals through one or more links (e.g., the links 200a-b and 600a-b) as has been described. As will be recognized by those skilled in the art, each of the communications components 141, 341, 541 and 741 are selected to be operable with whatever type of interface technology is selected to implement each of the interfaces 190, 390, 590 and 790.

Each of the control routines 140 and 740 comprise a user interface component 142 and 742, respectively, executable by corresponding ones of the processing circuits 150 and 750 to monitor corresponding ones of the controls 120 and 720 to receive indications of operation associated with user input, and to cause various forms of information to be visually presented on corresponding ones of the displays 180 and 780. As will be recognized by those skilled in the art, each of the user interface components 142 and 742 are selected to be operable with whatever type of interface technology is selected to monitor the controls 120 and 720, and with whatever type of interface technology is selected to drive the presentation of information on to the displays 180 and 780. In various embodiments, one or both of the user interface components 142 and 742 may comprise a web browser, email client, terminal emulator or other executable sequence of instructions enabling a user of one or both of the computing devices 100 and 700 to remotely interact with other computing devices (e.g., the transaction server 300 and/or the verification server 500) via corresponding ones of the communications components 141 and 741, and the interfaces 190 and 790.

The control routine 340 comprises a transaction component 343 executable by the processing circuit 350 to perform transactions for which transaction requests are received via the communications component 341 and the interface 390 (e.g., from the transaction device 100) as has been described. In various embodiments, the transaction component 343 may comprise a web server providing a webpage viewable through use of a user interface component of a remotely located computing device (e.g., the user interface component 142 of the transaction device 100).

Each of the control routines 340, 540 and 740 comprise a verification component 344, 544 and 744, respectively, executable by corresponding ones of the processing circuits 350, 550 and 750 to enable cooperation among the computing devices 300, 500 and 700 to verify that a requested transaction is actually requested by the person indicated in its transaction request, as has been described. In various embodiments, the verification component 344 may comprise an application-level executable sequence of instructions executed by the processor circuit 350 in cooperation with the transaction component 343 to seek verification of the purported identity of a person indicated in a transaction request for the transaction component 343 to perform a transaction. The verification component 344 transmits a verification request via the communications component 341 and the interface 390 to the verification server 500, and awaits an indication of a response or lack of response to the verification request. The verification component 544 receives the verification request transmitted by the verification component 344 via the communications component 541 and the interface 590, and responds by retrieving the identity of the transaction device 700 from the verification device data 549, and transmitting a verification request via the communications component 541 and the interface 590 to the verification device 700. The verification component 544 then awaits an indication of a response or lack of response to the verification request.

In various embodiments, the verification component 744 comprises an application-level executable sequence of instructions executed in cooperation with the user interface component 742 to present a request to a user of the verification device 700 to verify that they did request performance of the requested transaction. The verification component 744 receives the verification request from the verification server 500 via the communications component 741 and the interface 790. The verification component 744 then responds to the receipt of this verification request by presenting the request to the user on the display 780 via the user interface component 742, and monitoring for a response from the user in the form of operation of the controls 720 via the user interface component 742. The verification component 744 then transmits an indication of the response or lack of response to the verification server 500 via the communications component 741 and the interface 790, where in turn, the verification component 544 receives the indication and relays a corresponding indication to the transaction server 300 via the communications component 541 and the interface 590. The verification component 344 receives the relayed indication of a response or lack of response via the communications component 341 and the interface 390, and cooperates with the transaction component 343 to either perform or deny the requested transaction, as appropriate.

In one example embodiment, the transaction device 100 is a computing device operated by a person either at their home or where they work to perform a transaction involving an account associated with that person at a financial institution with which the transaction server 300 is also associated, and at which this person is a customer. The financial institution may have selected a verification service provider, with which the verification server 500 is associated, at some time in the past to employ out-of-band electronic communications to verify that transaction requests received by the financial institution are actually originated by the customers and are not fraudulent. This person operating the transaction device 100 also owns the verification device 700, which is a smartphone that the person earlier registered with the verification service provider selected by the financial institution as a computing device that may be used to reach the person to verify transaction requests purported to have originated from them.

In selecting the verification service provider with which the verification server 500 is associated, the verification component 344 may have been provided by that verification service provider to be installed on the transaction server 300 to enable the initiation and transmission of verification requests by the transaction server 300 to the verification server 500, as has been described. Similarly, in registering the verification device 700 with the same verification service provider, the verification component 744 may have been provided by that verification service provider to be installed (perhaps as an applet) on the verification device 700 to enable the verification device 700 to receive verification requests, and to present requests for verification on the display 780 and await a response via operation of the controls 720, as has been described. Further, in registering the verification device 700 with the verification service provider, data associating the identity of this person with the identity of the verification device 700 is stored in the storage 560 as part of the verification device data 549.

In response to this person operating the transaction device 100 to request a transaction, perhaps using a web browser (e.g., the user interface component 142), the transaction server 300 is caused to transmit a verification request to the verification server 500. In response to receiving this verification request, the verification server 500 retrieves the identity of the verification device 700 from the verification device data 549, and transmits a verification request to the verification device 700, thereby enabling this person to operate the verification device 700 to answer the request for verification presented on the display 780 with an affirmative indication that it is this person who requested the transaction. An indication of this response is then relayed back to the transaction server 300 as previously described.

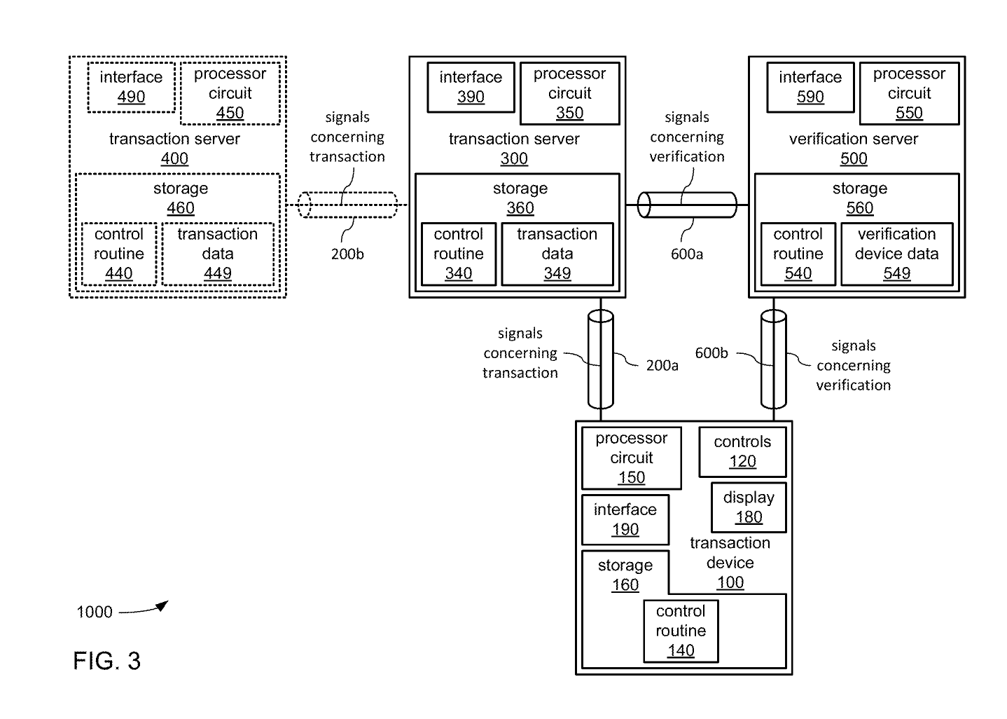

FIG. 3 illustrates a block diagram of a variation of the transaction system 1000 of FIG. 1. This variation depicted in FIG. 3 is similar to what is depicted in FIG. 1 in many ways, and thus, like reference numerals are used to refer to like elements throughout. A person's use of the transaction device 100 to communicate with the transaction server 300 to request the performance of a transaction is still responded to by the transaction server 300 transmitting a verification request to the verification server 500, thereby triggering the verification server 500 to transmit a verification request to a verification device registered with the verification server 500 for reaching the person identified in the transaction request as purportedly being the person requesting the transaction. However, a difference in the FIG. 3 variation from what was depicted in FIG. 1 is that the computing device registered with the verification server 500 as being the verification device is the transaction device 100, such that the transaction device 100 serves in two of the roles originally described with regard to FIG. 1.

In this variation of FIG. 3, the verification component 741 that may have been a part of the control routine 740 of what would have been the separate verification device 700 may, instead, be incorporated into the control routine 140 of the transaction device 100. Thus, if the earlier-described example of a person operating the transaction device 100 to request performance of a transaction by the transaction server 300 were modified for this variation of FIG. 3, the person would have registered the transaction device 100 at an earlier time with the verification service provider associated with the verification server 500, instead of the verification device 700 of FIG. 1. Under such circumstances, the verification component 741 may have been provided by the verification service provider to install on the transaction device 100, instead.

Despite the combining of the verification device 700 (and its role in verification) into the transaction device 100, such that the transaction device 100 now serves two roles, a separate communications channel (e.g., the combination of the links 600a and 600b) is still employed in seeking verification that the person purported to have requested a transaction really is the person who has done so. Thus, this may be deemed to still provide adequate verification, since an extra distinct action is still required on the part of the person requesting the transaction to verify their request before the transaction can proceed.

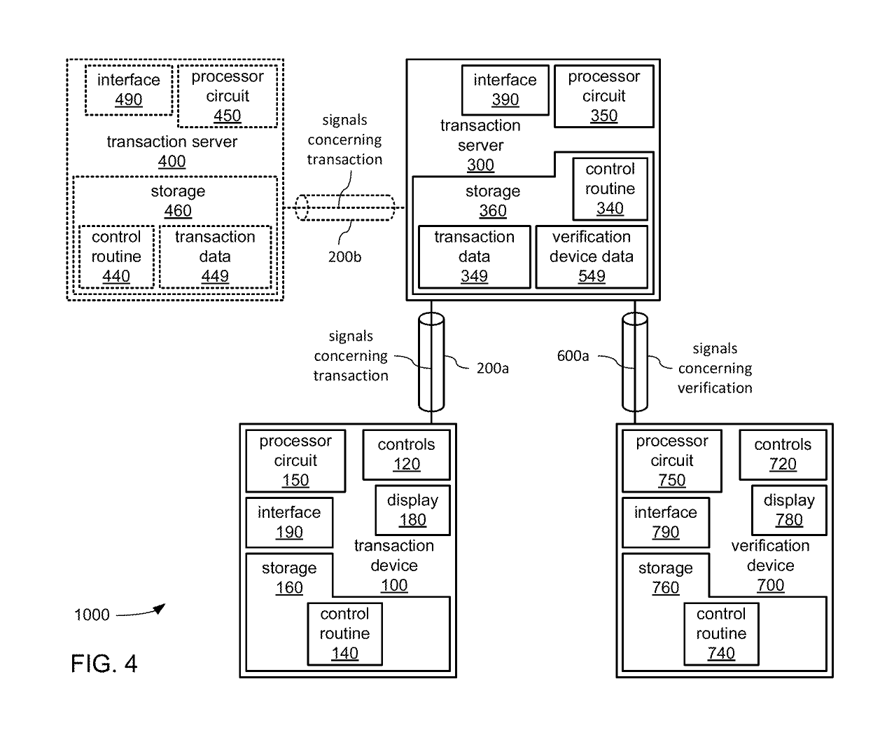

FIG. 4 illustrates a block diagram of another variation of the transaction system 1000 of FIG. 1. This variation depicted in FIG. 4 is similar to what is depicted in FIG. 1 in many ways, and thus, like reference numerals are used to refer to like elements throughout. A person's use of the transaction device 100 to communicate with the transaction server 300 to request the performance of a transaction is still responded to by the transaction server 300 transmitting a verification request. However, a difference in the FIG. 4 variation from what was depicted in FIG. 1 is that the verification device 700 is registered with the transaction server 300, rather than with a separate verification server, as being the verification device. Thus, the verification device data 549 is stored within the storage 360 of the transaction server 300, and the transaction server 300 retrieves the identity of the verification device 700 from the verification device data 549. The transaction server 300 then uses that identification information to transmit a verification request directly to the verification device 700, and awaits an indication of a response or lack of response directly from the verification device 700.

In this variation of FIG. 4, the verification component 544 that may have been a part of the control routine 540 of what would have been the separate verification server 500 may, instead, be incorporated into the control routine 340 of the transaction server 300. Thus, if the earlier-described example of a person operating the transaction device 100 to request performance of a transaction by the transaction server 300 were modified for this variation of FIG. 4, the person would have registered the verification device 700 at an earlier time with the transaction server 300 associated with the financial institution, instead of with a verification server of a separate verification service provider. Under such circumstances, the verification component 741 may have been provided by the financial institution to install on the verification device 700, instead of a verification service provider.

Despite the combining of the verification server 500 (and its role in verification) into the transaction server 300, such that the transaction server 300 now serves two roles, a separate communications channel (e.g., the link 600a) is still employed in seeking verification that the person purported to have requested a transaction really is the person who has done so.

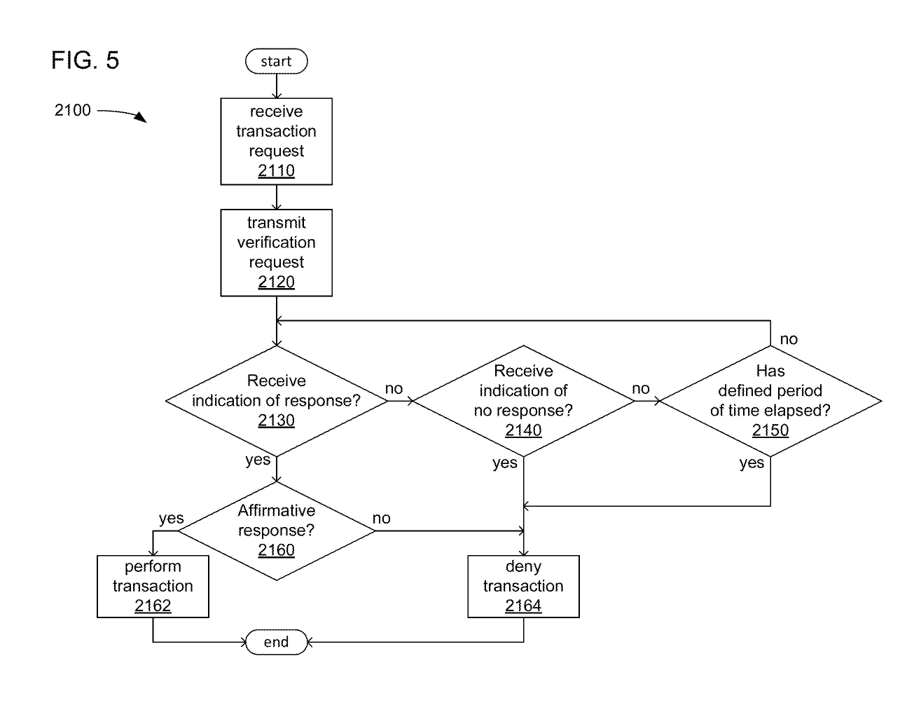

FIG. 5 illustrates one embodiment of a logic flow 2100. The logic flow 2100 may be representative of some or all of the operations executed by one or more embodiments described herein. More specifically, the logic flow 2100 may illustrate operations performed by the processing circuit 350 of the transaction server 300 in executing at least the control routine 340.

At 2110, a transaction server (e.g., the transaction server 300) receives a transaction request to perform a transaction from a transaction device (e.g., the transaction device 100). The transaction requests comprises indications of various details required by the transaction server to perform the transaction (e.g., amount, item to be transferred, to whom or from whom an amount or thing is to be transferred, etc.) The transaction request purports to provide an indication of the identity of the person making the request, but as has been discussed at length, this purported identity remains to be verified.

At 2120, the transaction server transmits a verification request. As has been discussed, in different variants, this verification request may be transmitted to a verification server (e.g., the verification server 500) to be relayed to a verification device (e.g., the verification device 700, or the transaction device 100 serving in the role of a verification device) that has been registered as being associated with the person identified in the transaction request, or this verification request may be transmitted to the verification device where the verification device has been registered with the transaction server such that the transaction server is able, itself, to retrieve information identifying the verification device.

At 2130, a check is made as to whether the transaction server has received an indication that the verification request has been responded to. If an indication is received to the effect that the verification request has been responded to, then at 2160, a check is made as to whether the response is an affirmative response that verifies that the person identified in the transaction request did indeed request the transaction. If such an affirmative response has been received, then the transaction server performs the transaction at 2162. As previously discussed, if the transaction server requires the cooperation of another transaction server to perform the transaction (e.g., the transaction server 400), then the transaction server signals the other transaction server to engage in that cooperation. However, if the response is a negative response indicating that the person identified in the transaction request did not request the transaction, then the transaction server denies the transaction at 2164.

However, if no indication of the verification request being responded to has yet been received at 2130, then a check is made at 2140 of whether or not an indication has been received of their being no response to the verification request. Such an indication of there being no response may be received by the transaction server where a verification server and/or a verification device has determined that a defined amount of time tracked by one or both of those computing devices has elapsed without a response from the person registered as associated with the verification device such that it is deemed unlikely that the registered person is going to respond. If such an indication of there having been no response is received, then the transaction server denies the transaction at 2164.

However, if no indication of there being no response from the registered person has been received at 2140, then a check may be made at 2150 as to whether a defined period of time tracked by the transaction server has elapsed since the transaction server transmitted the verification request. If that defined period of time has elapsed, then the transaction server may deny the transaction at 2164. However, if that defined period of time has not elapsed, then the transaction server may check again at 2130 whether or not the transaction server has yet received an indication of a response from the registered person. In one possible alternate variation, at least one instance of the elapsing of the defined period of time tracked by the transaction server at 2150 may trigger the transaction server to retransmit the verification request and wait for some further period of time, at least before denying the transaction at 2164.

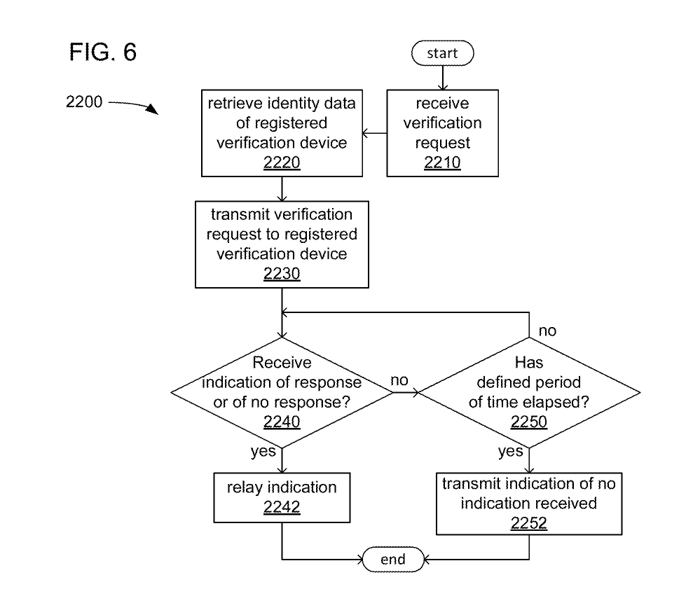

FIG. 6 illustrates one embodiment of a logic flow 2200. The logic flow 2200 may be representative of some or all of the operations executed by one or more embodiments described herein. More specifically, the logic flow 2200 may illustrate operations performed by the processing circuit 550 of the verification server 500 in executing at least the control routine 540.

At 2210, a verification server (e.g., the verification server 500) receives a verification request from a transaction server (e.g., the transaction server 300). The verification request comprises an indication of at least one aspect of the transaction requested to be performed by the transaction server in a transaction request (e.g., an amount, a description of an item of value, to whom or from whom an amount or thing is to be transferred, etc.). The verification request also comprises an indication of the identity specified in the transaction request of the person purported to have requested the transaction, this purported identity remaining to be verified.

At 2220, the verification server employs the indication of the identity of the person purportedly requesting the transaction to retrieve information (perhaps from data stored within a storage of the verification server) that identifies a verification device previously registered with the verification server as being associated with that person (e.g., the verification device 700, or the transaction device 100 additionally serving as a verification device). At 2230, the verification server uses the retrieved information identifying the verification device to signal the verification device with a verification request.

At 2240, a check is made as to whether the verification server has received an indication that the verification request has either been responded to, or not, from the verification device. If an indication is received to either effect, then the verification server relays that indication to the transaction server at 2242.

However, if no indication to either effect has been received from the verification device at 2240, then a check may be made at 2250 as to whether a defined period of time tracked by the verification server has elapsed since the verification server transmitted the verification request to the verification device. If that defined period of time has elapsed, then the verification server may transmit an indication of having received no response from the verification device to the transaction server at 2252. However, if that defined period of time has not elapsed, then the transaction verification server may check again at 2240 whether or not the verification server has yet received an indication to either effect from the verification device. In one possible alternate variation, at least one instance of the elapsing of the defined period of time tracked by the verification server at 2250 may trigger the verification server to retransmit the verification request to the verification device and wait for some further period of time, at least before transmitting an indication of having received no response at 2252.

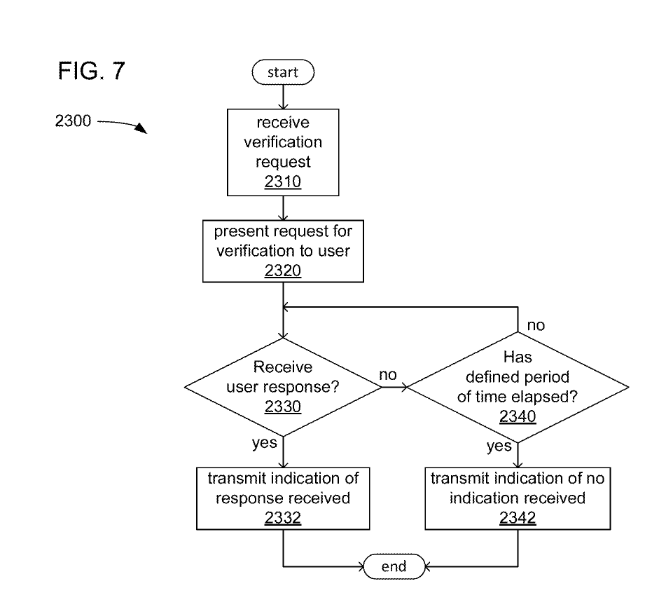

FIG. 7 illustrates one embodiment of a logic flow 2300. The logic flow 2300 may be representative of some or all of the operations executed by one or more embodiments described herein. More specifically, the logic flow 2300 may illustrate operations performed by the processing circuit 750 of the verification device 700 in executing at least the control routine 740.

At 2310, a verification device (e.g., the verification device 700) receives a verification request from a verification server (e.g., the verification server 500, or the transaction server 300 additionally serving in the role of a verification server). The verification request comprises an indication of at least one aspect of the transaction requested to be performed by the transaction server in a transaction request (e.g., an amount, a description of an item of value, to whom or from whom an amount or thing is to be transferred, etc.). The verification request also comprises an indication of the identity specified in the transaction request of the person purported to have requested the transaction, this purported identity remaining to be verified.

At 2320, the verification device presents a request for its user to verify that he/she has requested the transaction. As previously discussed, this presentation of this request may be visual (e.g., visually presented on a display, such as the display 780 of the verification device 700), audible and/or made in some other perceivable manner.

At 2330, a check is made as to whether the user of the verification device has operated controls of the verification device to signal a response to the presented request for verification. If a user response has been received, then the verification device transmits an indication of that response to the verification server at 2332.

However, if no response has been received from the user at 2332, then a check may be made at 2340 as to whether a defined period of time tracked by the verification device has elapsed since the verification device presented the request for verification. If that defined period of time has elapsed, then the verification device may transmit an indication of having received no response to the presented request for verification to the verification server at 2342. However, if that defined period of time has not elapsed, then the verification device may check again at 2330 whether or not a response to the presented request for verification has been received from the user. In one possible alternate variation, at least one instance of the elapsing of the defined period of time tracked by the verification device at 2340 may trigger the verification device to again present the request for verification to the user (perhaps altering the manner of presentation) and wait for some further period of time, at least before transmitting an indication of having received no response at 2342.

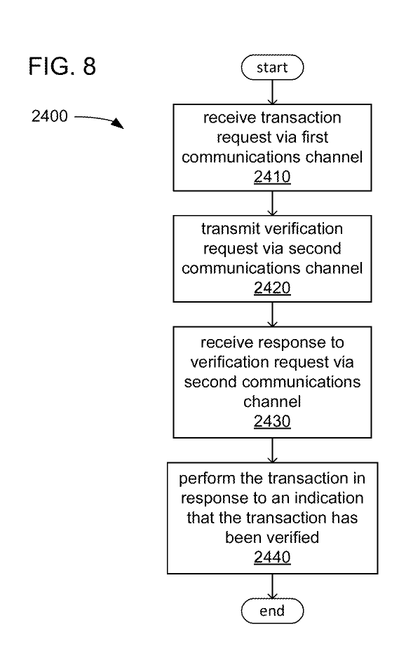

FIG. 8 illustrates one embodiment of a logic flow 2400. The logic flow 2400 may be representative of some or all of the operations executed by one or more embodiments described herein. More specifically, the logic flow 2400 may illustrate operations performed by the processing circuit 350 of the transaction server 300 in executing at least the control routine 340.

At 2410, a transaction server (e.g., the transaction server 300) receives a transaction request from a transaction device (e.g., the transaction device 100) through a first communications channel. The transaction request comprises an indication of at least one aspect of the transaction requested to be performed by the transaction server, and also comprises an indication of the identity of the person purported to have requested the transaction.

At 2420, the transaction server transmits a verification request via a second communications channel to another computing device (e.g., the verification server 500 or the verification device 700). The verification request comprises an indication of at least the identity specified in the transaction request of the person who purportedly requested the transaction.

At 2430, the transaction server receives a response to the verification request via the second communications channel from the other computing device.

At 2440, the transaction server performs the requested transaction in response to the response to the verification request conveying an indication that the transaction has been verified, i.e., that it has been verified that the person purported to have requested the transaction actually did so. It may be that the transaction device further transmits an indication to the transaction device via the first communications channel to the effect that the transaction has been verified and/or has been (and/or is being) performed.

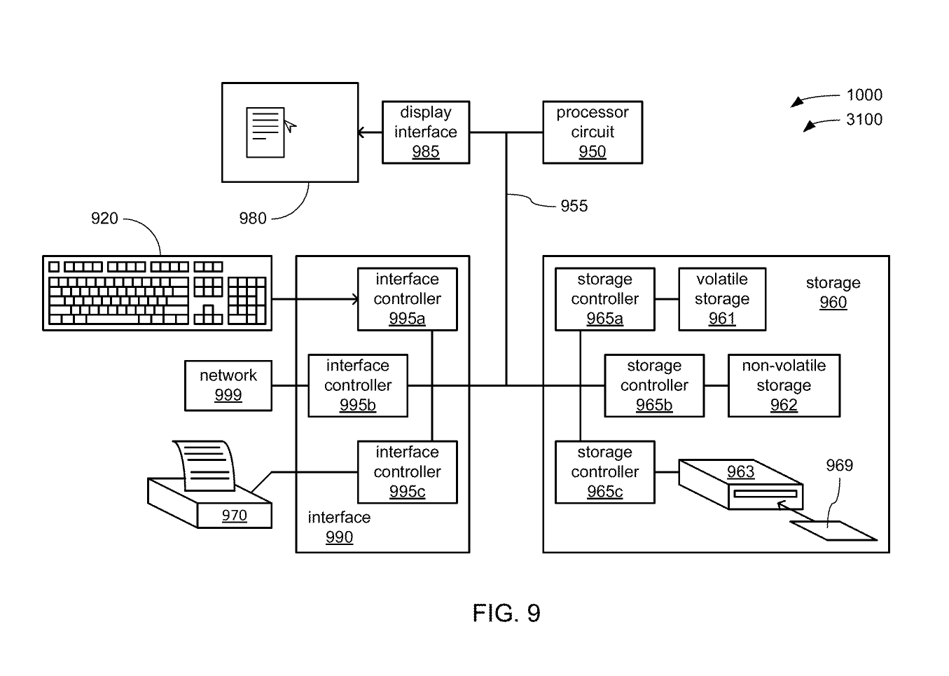

FIG. 9 illustrates an embodiment of an exemplary processing architecture 3100 suitable for implementing various embodiments as previously described. More specifically, the processing architecture 3100 (or variants thereof) may be implemented as part of one or more of the computing devices 100, 300, 400, 500 and 700. It should be noted that components of the processing architecture 3100 are given reference numbers in which the last two digits correspond to the last two digits of reference numbers of components earlier depicted and described as part of each of the computing devices 100, 300, 400, 500 and 700. This is done as an aid to correlating such components of whichever ones of the computing devices 100, 300, 400, 500 or 700 may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3100, a computing device comprises at least a processor circuit 950, a storage 960, an interface 990 to other devices, and coupling 955. As will be explained, depending on various aspects of a computing device implementing the processing architecture 3100, including its intended use and/or conditions of use, such a computing device may further comprise additional components, such as without limitation, a display interface 985.

Coupling 955 is comprised of one or more buses, point-to-point interconnects, transceivers, buffers, crosspoint switches, and/or other conductors and/or logic that communicatively couples at least the processor circuit 950 to the storage 960. Coupling 955 may further couple the processor circuit 950 to one or more of the interface 990 and the display interface 985 (depending on which of these and/or other components are also present). With the processor circuit 950 being so coupled by couplings 955, the processor circuit 950 is able to perform the various ones of the tasks described at length, above, for whichever ones of the computing devices 100, 300, 400, 500 or 700 implement the processing architecture 3100. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to one or more of the processor circuits 150, 350, 450, 550 or 750) may comprise any of a wide variety of commercially available processors, employing any of a wide variety of technologies and implemented with one or more cores physically combined in any of a number of ways.

As previously discussed, the storage 960 (corresponding to one or more of the storages 160, 360, 460, 560 or 760) may comprise one or more distinct storage devices based on any of a wide variety of technologies or combinations of technologies. More specifically, as depicted, the storage 960 may comprise one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and comprises one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and comprises one or more optical and/or solid-state disk drives employing one or more pieces of machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may comprise an article of manufacture in the form of a machine-readable storage media on which a routine comprising a sequence of instructions executable by the processor circuit 950 may be stored, depending on the technologies on which each is based. By way of example, where the non-volatile storage 962 comprises ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may comprise banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 950 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor circuit 950 as that routine is executed.

As previously discussed, the interface 990 (corresponding to one or more of the interfaces 190, 390, 490, 590 and 790) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 970) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920 (perhaps corresponding to one or both of the controls 120 and 720). The interface controller 995b may employ any of a variety of cabling-based or wireless signaling, timings and/or protocols to access other computing devices through the depicted network 999 (perhaps a network comprising one or more of the links 200a-b and/or 600a-b, perhaps the Internet). The interface 995c may employ any of a variety of electrically conductive cabling enabling the use of either serial or parallel signal transmission to convey data to the depicted printer 970. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually comprises) a display (e.g., the depicted example display 980, corresponding to one or both of the displays 180 and 780), such a computing device implementing the processing architecture 3100 may also comprise the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the devices 100, 300, 400, 500 and 700 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example apparatus comprises a processor circuit and a storage communicatively coupled to the processor circuit and storing a sequence of instructions. The instructions are operative on the processor circuit to receive a transaction request requesting performance of a transaction via a first communications channel from a transaction device; transmit a verification request to another computing device via a second communications channel; receive a response to the verification request via the second communications channel; and perform the transaction in response to an indication in the response that the transaction has been verified.

The above example of apparatus in which the instructions are operative on the processor circuit to transmit an indication to the transaction device that the transaction is denied in response to an indication in the response that the transaction has not been verified.

Either of the above examples of apparatus in which the instructions are operative on the processor circuit to transmit an indication to the transaction device that the transaction is denied in response to a defined period of time elapsing since transmitting the verification request during which no response to the verification request is received.

Any of the above examples of apparatus in which transmitting the verification request to the other computing device comprises transmitting the verification request to a verification server to cause the verification server to identify a verification device and to signal the verification device to present a request for verification of the transaction.

Any of the above examples of apparatus in which the instructions are operative on the processor circuit to retrieve data identifying a verification device from the storage, and in which transmitting the verification request to the other computing device comprises transmitting the verification request to the verification device to signal the verification device to present a request for verification of the transaction.

Any of the above examples of apparatus in which presenting the request comprises generating one or more of a visual, audible or tactile request for input to the verification device to verify the transaction.

Any of the above examples of apparatus in which the transaction comprises one of a financial transaction, a monetary transaction or a secured transaction.

Any of the above examples of apparatus in which the first and second communications channels comprise separate virtual channels formed through the Internet.

An example of another apparatus comprises a processor circuit and a storage communicatively coupled to the processor circuit and storing a sequence of instructions. The instructions are operative on the processor circuit to receive a verification request concerning a transaction request received by a transaction server via a first communications channel that requests performance of a transaction, the verification request received by the apparatus from another computing device through a second communications channel; present a request for input to the apparatus to verify the transaction; and transmit a response to the verification request to the other computing device via the second communications channel.

The above example of another apparatus in which the transaction comprises one of a financial transaction, a monetary transaction or a secured transaction.

Either of the above examples of another apparatus in which presenting the request comprises generating one or more of a visual, audible or tactile request for input to the apparatus to verify the transaction.

Any of the above examples of another apparatus in which the instructions are operative on the processor circuit to receive an input indicating whether the transaction is verified, and convey the indication in the response.

Any of the above examples of another apparatus in which receiving the input comprises one or more of receiving a signal indicative of manual operation of a manual control of the apparatus, speech detected by a microphone of the apparatus, or a gesture detected by a camera of the apparatus.

Any of the above examples of another apparatus in which the instructions are operative on the processor circuit to convey an indication of there being no response to presenting the request in response to a defined period of time elapsing since presenting the request during which no response to the request has been received.

Any of the above examples of another apparatus in which the transaction device and the apparatus are the same computing device, and the first and second communications channels comprising separate virtual communications channels.

An example of computer-implemented method comprises receiving a transaction request from a transaction device via a first communications channel, the transaction request requesting performance of a transaction; retrieving data identifying a verification device; transmitting a verification request to the verification device via a second communications channel; receiving a response to the verification request from the verification device via the second communications channel; and performing the transaction in response to an indication in the response that the transaction has been verified.

The above example of computer-implemented method comprises transmitting via the first communications channel an indication to the transaction device that the transaction is denied in response to an indication in the response that the transaction has not been verified.

Either of the above examples of computer-implemented method comprises transmitting via the first communications channel an indication to the transaction device that the transaction is denied in response to a defined period of time elapsing since transmitting the verification request during which no response to the verification request is received.

Any of the above examples of computer-implemented method in which transmitting the verification request to the verification device comprises signaling the verification device to present a request for verification of the transaction.

Any of the above examples of computer-implemented method in which presenting the request comprises generating one or more of a visual, audible or tactile request for input to the verification device to verify the transaction.

Any of the above examples of computer-implemented method in which the transaction comprises one of a financial transaction, a monetary transaction or a secured transaction.

Any of the above examples of computer-implemented method in which the first and second communications channels comprise separate virtual channels formed through the Internet.

An example of at least one machine-readable storage medium comprises instructions that when executed by a computing device, cause the computing device to receive an indication of a transaction device transmitting a transaction request via a first communications channel, the transaction request requesting performance of a transaction; retrieve data identifying a verification device; transmit a verification request to the verification device via a second communications channel; receive a response to the verification request from the verification device via the second communications channel; and cause the transaction to be performed in response to an indication in the response that the transaction has been verified.

The above example of at least one machine-readable storage medium in which causing the transaction to be performed comprises transmitting an indication to a transaction server that the transaction has been verified to signal the transaction server to perform the transaction, the transaction server receiving the transaction request via the first communications channel.

Either of the above examples of at least one machine-readable storage medium in which the computing device is caused to transmit an indication to a transaction server that the transaction has not been verified to signal the transaction server to transmit an indication to the transaction device that the transaction is denied in response to an indication in the response that the transaction has not been verified.

Any of the above examples of at least one machine-readable storage medium in which transmitting the verification request to the verification device comprises signaling the verification device to present a request for verification of the transaction.

Any of the above examples of at least one machine-readable storage medium in which presenting the request comprises generating one or more of a visual, audible or tactile request for input to the verification device to verify the transaction.

Any of the above examples of at least one machine-readable storage medium in which the transaction comprises one of a financial transaction, a monetary transaction or a secured transaction.

1. An apparatus comprising:
a processor circuit; and
a storage communicatively coupled to the processor circuit and storing a sequence of instructions operative on the processor circuit to:
receive a transaction request requesting performance of a transaction via a first communications channel from a transaction device;
transmit a verification request to another computing device via a second communications channel;
receive a response to the verification request via the second communications channel; and
perform the transaction in response to an indication in the response that the transaction has been verified.

2. The apparatus of claim 1, the instructions operative on the processor circuit to transmit an indication to the transaction device that the transaction is denied in response to an indication in the response that the transaction has not been verified.

3. The apparatus of claim 1, the instructions operative on the processor circuit to transmit an indication to the transaction device that the transaction is denied in response to a defined period of time elapsing since transmitting the verification request during which no response to the verification request is received.

4. The apparatus of claim 1, transmitting the verification request to the other computing device comprises transmitting the verification request to a verification server to cause the verification server to identify a verification device and to signal the verification device to present a request for verification of the transaction.

5. The apparatus of claim 1, the instructions operative on the processor circuit to retrieve data identifying a verification device from the storage, and transmitting the verification request to the other computing device comprises transmitting the verification request to the verification device to signal the verification device to present a request for verification of the transaction.

6. The apparatus of claim 5, presenting the request comprises generating one or more of a visual, audible or tactile request for input to the verification device to verify the transaction.

7. The apparatus of claim 1, the transaction comprising one of a financial transaction, a monetary transaction or a secured transaction.

8. The apparatus of claim 1, the first and second communications channels comprising separate virtual channels formed through the Internet.

9. An apparatus comprising:
a processor circuit; and
a storage communicatively coupled to the processor circuit and storing a sequence of instructions operative on the processor circuit to:
receive a verification request concerning a transaction request received by a transaction server via a first communications channel that requests performance of a transaction, the verification request received by the apparatus from another computing device through a second communications channel;
present a request for input to the apparatus to verify the transaction; and
transmit a response to the verification request to the other computing device via the second communications channel.

10. The apparatus of claim 9, the transaction comprising one of a financial transaction, a monetary transaction or a secured transaction.

11. The apparatus of claim 9, presenting the request comprises generating one or more of a visual, audible or tactile request for input to the apparatus to verify the transaction.

12. The apparatus of claim 9, the instructions operative on the processor circuit to receive an input indicating whether the transaction is verified, and convey the indication in the response.

13. The apparatus of claim 12, receiving the input comprises one or more of receiving a signal indicative of manual operation of a manual control of the apparatus, speech detected by a microphone of the apparatus, or a gesture detected by a camera of the apparatus.

14. The apparatus of claim 9, the instructions operative on the processor circuit to convey an indication of there being no response to presenting the request in response to a defined period of time elapsing since presenting the request during which no response to the request has been received.

15. The apparatus of claim 9, the apparatus comprising the transaction device such that they are the same computing device, and the first and second communications channels comprising separate virtual communications channels.

16. A computer-implemented method comprising:
receiving a transaction request from a transaction device via a first communications channel, the transaction request requesting performance of a transaction;
retrieving data identifying a verification device;
transmitting a verification request to the verification device via a second communications channel;
receiving a response to the verification request from the verification device via the second communications channel; and
performing the transaction in response to an indication in the response that the transaction has been verified.

17. The computer-implemented method of claim 16, comprising transmitting via the first communications channel an indication to the transaction device that the transaction is denied in response to an indication in the response that the transaction has not been verified.

18. The computer-implemented method of claim 16, comprising transmitting via the first communications channel an indication to the transaction device that the transaction is denied in response to a defined period of time elapsing since transmitting the verification request during which no response to the verification request is received.

19. The computer-implemented method of claim 16, transmitting the verification request to the verification device comprises signaling the verification device to present a request for verification of the transaction.

20. The computer-implemented method of claim 19, presenting the request comprises generating one or more of a visual, audible or tactile request for input to the verification device to verify the transaction.

21. The computer-implemented method of claim 16, the transaction comprising one of a financial transaction, a monetary transaction or a secured transaction.

22. The computer-implemented method of claim 16, the first and second communications channels comprising separate virtual channels formed through the Internet.

23. At least one machine-readable storage medium comprising instructions that when executed by a computing device, cause the computing device to:
receive an indication of a transaction device transmitting a transaction request via a first communications channel, the transaction request requesting performance of a transaction;
retrieve data identifying a verification device;
transmit a verification request to the verification device via a second communications channel;
receive a response to the verification request from the verification device via the second communications channel; and
cause the transaction to be performed in response to an indication in the response that the transaction has been verified.

24. The at least one machine-readable storage medium of claim 23, causing the transaction to be performed comprises transmitting an indication to a transaction server that the transaction has been verified to signal the transaction server to perform the transaction, the transaction server receiving the transaction request via the first communications channel.

25. The at least one machine-readable storage medium of claim 23, the computing device caused to transmit an indication to a transaction server that the transaction has not been verified to signal the transaction server to transmit an indication to the transaction device that the transaction is denied in response to an indication in the response that the transaction has not been verified.

26. The at least one machine-readable storage medium of claim 23, transmitting the verification request to the verification device comprises signaling the verification device to present a request for verification of the transaction.

27. The at least one machine-readable storage medium of claim 26, presenting the request comprises generating one or more of a visual, audible or tactile request for input to the verification device to verify the transaction.

28. The at least one machine-readable storage medium of claim 23, the transaction comprising one of a financial transaction, a monetary transaction or a secured transaction.
